(19) United States
(12) Patent Application Publication
(10) Pub. No.: US 2024/0093698 A1
(43) Pub. Date: Mar. 21, 2024

(54) Production of a Diffusor as a Group of Channels

(71) Applicant: KSB SE & Co. KGaA, Frankenthal (DE)

(72) Inventors: Tammuz NOBEL, Frankenthal (DE); Berthold MATZ, Frankenthal (DE)

(21) Appl. No.: 18/267,155

(22) PCT Filed: Nov. 10, 2021
(86) PCT No.: PCT/EP2021/081200

§ 371 Date: Jun. 14, 2023

(30) Foreign Application Priority Data
Dec. 15, 2020 (DE) 10 2020 133 459.1

(51) Int. Cl. F04D 29/44; F04D 1/06

(52) U.S. Cl. CPC F04D 29/445; F04D 1/06

(57) ABSTRACT

A centrifugal pump having at least one impeller is provided with a guide device arranged downstream of the impeller configured to convert a portion of the velocity of a flowing medium to an increased pressure in the medium. The guide device includes at least two generatively manufactured segments.

### CROSS REFERENCE TO RELATED APPLICATION

This application claims priority under 35 U.S.C. § 119 from German Patent Application No. 102020133459.1, filed Dec. 15, 2020, the entire disclosure of which is herein expressly incorporated by reference.

### BACKGROUND AND SUMMARY OF THE INVENTION

The invention relates to a centrifugal pump comprising at least one impeller, a guide device being arranged downstream thereof.

Such guide devices generally have guide blades. Guide channels for the conveyed medium are formed between the guide blades. Such guide devices can be configured as guide wheels. Conveyed medium exiting from the impeller enters the guide device. Kinetic energy is converted into pressure energy in the guide device. The medium is also deflected. If required, the swirl is reduced for an inflow into a further stage.

A centrifugal pump having a single-stage or multi-stage design and comprising at least one impeller is described in DE 39 12 279 C2. A guide wheel is arranged downstream of the impeller in the direction of flow. The guide wheel has a plurality of guide blades.

DE 10 2014 223 942 A1 describes a single-stage or multi-stage centrifugal pump comprising a guide device. The conveyed medium flows to a first impeller and is subjected to an increase in pressure thereby. A guide device is arranged downstream of the impeller, guiding elements being arranged on the guide channels thereof. The guide device can be configured as a diffusor.

A diffusor is a component which transfers a flow with specific initial values of flow rate and static pressure into a flow at a lower velocity and higher static pressure with as little loss as possible.

A characteristic feature of a diffusor is the flow guidance in a closed channel with cross sections becoming larger in the direction of flow. In centrifugal pump technology, the diffusor is very frequently used as a casing part on the pressure side in annular casing pumps and volute pumps, multi-stage centrifugal pumps and as a component in pipelines.

In conventional multi-stage centrifugal pumps, the fluid exiting from the impeller is initially decelerated in a downstream guide wheel and then supplied to the downstream return part in an overflow geometry. This results in greater construction effort in the radial direction.

It is the object of the invention to specify a centrifugal pump comprising a guide wheel and an installation space which is as small as possible in the radial direction. The centrifugal pump is intended to have an efficiency which is as high as possible. A flow separation is intended to be substantially prevented. A deceleration is also intended to be ensured with as little loss as possible. The centrifugal pump is intended to be characterized by a construction which is as cost-effective as possible and by a mode of operation which is as reliable as possible. A service life which is as long as possible is also intended to be achieved.

This object is achieved according to the invention by a centrifugal pump comprising at least one impeller. Preferred variants are to be found in the dependent claims, the description and the drawings.

According to the invention, a centrifugal pump comprises at least one impeller, a guide device being arranged downstream thereof. This guide device is formed from at least two generatively manufactured segments.

Generative or additive manufacturing methods are understood to mean methods in which material is applied layer-by-layer and thus three-dimensional components are generated. In particular, selective laser melting, cold gas spraying and extrusion, in combination with the application of meltable plastics, are used for forming the segments.

A segment is a part of a whole and thus the assembly, in particular the joining together, of segments results in a whole component. Advantageously, the segmented configuration and the joining together of the generatively manufactured segments permits guide devices, in particular diffusors, as groups of channels which can have dimensions which previously could not be achieved with an unsegmented configuration.

Hitherto, generatively manufactured guide devices could not be used for the application of multi-component high pressure centrifugal pumps and boiler feed pumps, since the dimensions thereof were technically impossible to produce, or could only be produced with difficulty. Generatively manufactured guide devices are characterized by hydraulically optimized geometries which cannot be achieved by machining or casting manufacturing methods. The configuration of a complex guide device in segments permits, on the one hand, a hydraulically optimized geometry and, on the other hand, component sizes which exceed the known manufacturing dimensions.

According to the invention, a segment is configured as a channel. Advantageously, by means of generative manufacturing it is possible to configure a channel which was previously determined in an optimized manner using a computer-aided simulation. Such a channel has improved hydraulic properties relative to guide devices which are attached to the pump casing, and results in improved overall pump efficiency.

Preferably, the cross section of a channel increases in the direction of flow. As a result, the flow rate of a conveyed fluid is reduced particularly efficiently and at the same time a higher static pressure is implemented.

Ideally, the channel has a curvature for deflecting the flow. As a result, the fluid to be conveyed is entirely received by the guide device from the impeller discharge and can be optimally supplied thereby to a downstream pump impeller. The curvature deflects the flow of the fluid in a particularly advantageous manner so that no flow separation is produced at the outlet of the curvature and a reinforcement of the guide device can be dispensed with.

According to the invention, a channel of a segment has shaped portions. Rounded portions, which reduce turbulence and thereby increase the efficiency of the centrifugal pump, are configured in the channel by means of the shaped portions.

Advantageously, a segment has at least one bore in order to form an axial diffusion flow. With a computer-based simulation, it is possible to design the arrangement of the bore in an optimized manner and to form the diffusion flow for reducing the diameter of the guide device.

According to the invention, the guide device comprises more than 5, preferably more than 7 segments, in particular more than 9 segments. With a large number of segments, and thus also of channels, the action of the diffusor can be implemented in an optimal manner.

Ideally, the segments can be connected to a guide device by an unreleasable connection, preferably a welded connection. Such a connection is characterized by its robust and durable design.

According to the invention, the walls of the segments are configured to be very thin and the segments have an internal lattice structure in order to increase the strength. In this advantageous manner, it is possible to achieve guide devices with a particularly excellent ratio of mass to component volume. In comparison with conventionally manufactured guide devices, the guide devices produced from generatively manufactured segments have an exceptionally low mass.

According to the invention, a guide device assembled from generatively manufactured segments is used as a diffusor for a centrifugal pump. The guide device according to the invention has a particularly round and curved shape of the channels. The flow guidance of the fluid inside the guide device is characterized in that it can be configured to be particularly turbulence-free and thus a high efficiency of the centrifugal pump can be achieved.

The manufacture of large guide devices in an integrated additive manufacturing method is also of particularly great advantage. It is possible to manufacture particularly complex and also large guide devices by the use of a particularly mobile robot arm, which has different tools for additive manufacturing and also for joining technology. For example, the channel segments can be produced by the tool from selective laser melting, the positioning of the segments can be carried out by a fixing tool and the connecting joints can be formed by a welding tool.

During the joining process, two or more solid bodies, the joining parts, are permanently connected together with a geometrically specific design. During the welding process, an unreleasable connection of the segments is produced by using heat and/or pressure, with or without welding filler materials. The filler materials are generally supplied in the form of rods or wires which are melted and solidified in the joint between the join partners in order to produce the connection. Welding is one of the material connecting methods, wherein connections are produced with a high degree of strength.

In an alternative variant of the invention, pressing could be used as a joining method. In this case, large forces bring about the formation of a permanent connection between the segments.

In a variant of the invention, the guide device can be formed from a different structural material. The structural material preferably comprises metallic powder particles, in particular low-alloy and/or high-alloy steel powder particles, and/or meltable plastics and/or a metal-polymer hybrid material.

Preferably, the structural material for producing the contact surface for the flowing fluid is metallic powder particles. In a variant of the invention, iron-containing and/or cobalt-containing powder particles are used to this end. These powder particles can contain additives, such as for example chromium, molybdenum or nickel.

According to the invention, the segments of the guide device are formed in an additive manufacturing method. The 3D shape of a segment which is configured as a channel is stored in software as a data set. A robot arm acts at the points at which the segment is intended to be configured, the robot having tools from different additive methods and forming layer-by-layer the contact surface for the flowing medium and the supporting lattice structure of the contact surfaces. Advantageously, the appropriate construction process for each structural material can be implemented successively or simultaneously for each layer, so that a complex segment consisting of different materials is produced, the regions thereof optimally being adapted to the requirements of the subsequent use.

In a variant of the invention, the lattice structure is produced by the tool which is used for melting layers in the additive manufacturing method, in which a pattern of dots consisting of meltable plastics is applied to a surface. A load-bearing structure, in particular in the form of a lattice and/or in the form of honeycombs, is produced by extrusion by means of a nozzle and subsequent hardening by cooling at the desired position. Since the supporting region of a segment is produced in a cavity-forming manner with a particularly load-bearing structure, a segment has an enormous strength with at the same time a very low mass. The construction of a segment generally takes place by a working plane being repeatedly traveled over in each case line-by-line and then the working plane being stacked upwardly so that the supporting region of a segment is produced.

In a particularly advantageous variant of the invention, the contact surface for the flowing fluid is produced from a structural material by successively melting and solidifying layers by means of radiation. The different properties of the regions of a segment are generated by variations in the radiation. A modification of the material properties is already undertaken during the construction of the segment by a targeted control of the local input of heat. As a result, it is possible to produce zones and joints having different material states of a chemically homogenous material and thus different properties in one region of the segment.

The metallic structural material is applied in powder form in a thin layer onto a plate. The powdery material is entirely remelted locally by means of radiation at the respectively desired points and after solidification forms a solid material layer. This base plate is then reduced by the amount of one layer thickness and powder is applied again. This cycle is repeated until all of the layers are remelted. The finished segment is cleaned of excess powder.

A laser beam which generates the segment from the individual powder layers can be used as the radiation, for example. The data for guiding the laser beam is generated by means of software on the basis of a 3D CAD body. As an alternative to selective laser melting, an electron beam (EBM) can also be used.

Further features and advantages of the invention are found in the description of exemplary embodiments, with reference to the drawings and from the drawings themselves.

### BRIEF DESCRIPTION OF THE DRAWINGS

FIG. 1 shows a multi-stage centrifugal pump according to the prior art,

FIG. 2 shows an improved design of a guide device in accordance with an embodiment of the present invention,

FIG. 3 shows a schematic view of a segment of the guide device of FIG. 2.

### DETAILED DESCRIPTION

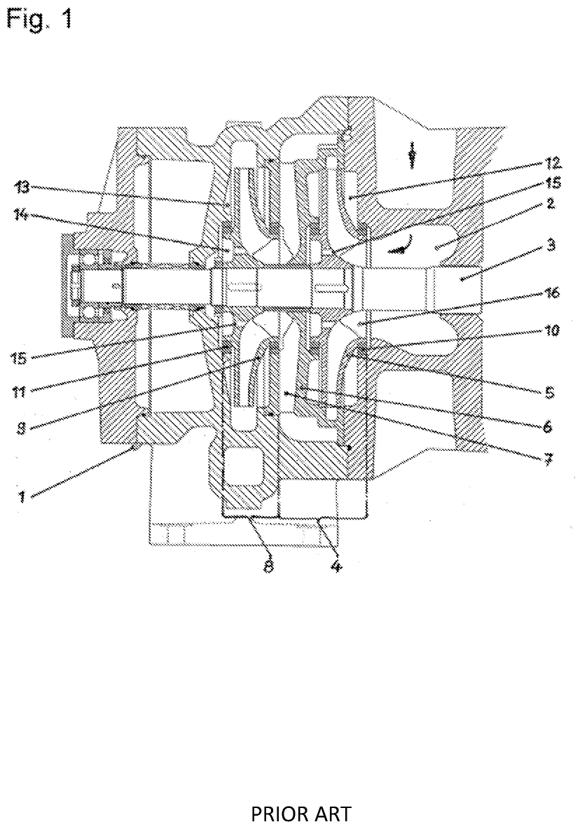

A known two-stage centrifugal pump 1 in a horizontal position and with a shaft 3 which is guided through a pump inlet 2 is shown in FIG. 1. A vertical or oblique position is also possible. A conveying fluid, for example an easily vaporizing or flammable fluid with a low boiling point, flows in the direction of the illustrated flow arrows of a first pump stage 4 comprising a first impeller of radial design. This first impeller, acting as a suction impeller 5, conveys fluid into a guide device 6 in which the kinetic energy of the fluid which is produced by the suction impeller 5 is converted into pressure energy. The guide device 6 is arranged downstream of a return blading 7, the fluid being conducted thereby to a second pump stage 8 comprising a second impeller 9.

The impeller 5 and the second impeller 9 are provided with gap seals 10, 11 on the suction side and on the pressure side. These seals reduce a return flow of conveyed fluid and define the impeller side chambers 12, 13 on the suction side and on the pressure side. In this case, the two impeller side chambers 13 on the pressure side enclose relief chambers 14 on the pressure side, from which a relief flow of a conveyed fluid, for the purpose of axial thrust relief, flows through the relief openings 15 back into the inlet region 16 of the impellers 5, 9.

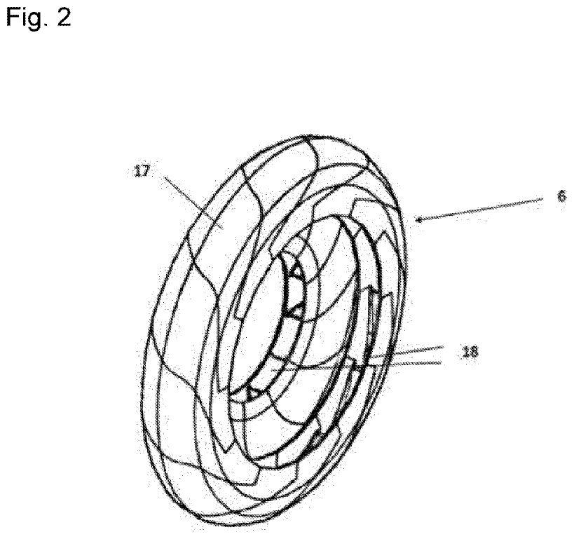

FIG. 2 shows a perspective view of an improved embodiment of the guide device 6. In the exemplary embodiment shown, the guide device 6 consists of twelve generatively manufactured segments 17 which have been connected by a joining method. Each segment 17 is configured in the form of a channel 18, the cross section thereof increasing in the direction of flow. The guide device 6 can receive the discharge of the impeller 5, deflect the flow and, by way of the channels 18 which are provided with the shaped portions, avoid turbulence and supply the flow to the following impeller 9.

The guide device 6 is characterized by particularly round and curved shaped portions inside the channel 18. In comparison with known impellers which deflect the fluid flow by return bladings 7 attached to the casing wall, the guide device 6 shown here is characterized by a flow guidance which can achieve a particularly high degree of efficiency of the centrifugal pump.

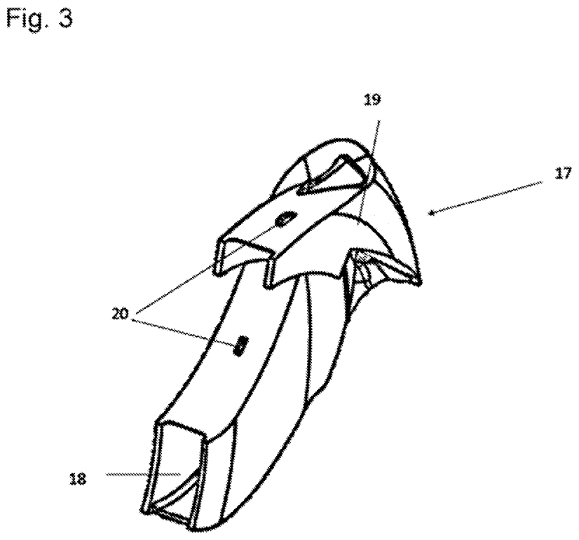

FIG. 3 shows a schematic view of a segment 17 of the guide device 6. The segment 17 is configured in the form of a channel, the cross section thereof increasing in the direction of flow of the fluid. The channel 18 has a curvature 19 for deflecting the fluid flow which is supplied to the impeller 9 from the impeller discharge of the impeller 5. The segment 17 has at least one bore 20 for forming a diffusion flow. The arrangement of the bore or the bores 20 was previously determined by CFD simulation. The axial and radial flow of the fluid is optimized such that a minimal diameter of the guide device 6 can be achieved.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A centrifugal pump, comprising:
at least one impeller; and
a guide device arranged downstream of the at least one impeller,
wherein the guide device is formed from at least two generatively manufactured segments.

12. The centrifugal pump as claimed in claim 11, wherein
at least one of the generatively manufactured segments is configured as a channel.

13. The centrifugal pump as claimed in claim 12, wherein
a cross section of the channel increases in a direction of flow.

14. The centrifugal pump as claimed in claim 13, wherein
the channel has a flow-deflecting curvature.

15. The centrifugal pump as claimed in claim 14, wherein
the channel has portions with a turbulence reducing shape.

16. The centrifugal pump as claimed in claim 11, wherein
at least one of the generatively manufactured segments has at least one axial diffusion bore.

17. The centrifugal pump as claimed in claim 11, wherein
the at least two generatively manufactured segments of the guide device includes at least 5 segments.

18. The centrifugal pump as claimed in claim 11, wherein
the at least two generatively manufactured segments of the guide device includes at least 9 segments.

19. The centrifugal pump as claimed in claim 11, wherein
the at least two generatively manufactured segments are connected by an unreleasable connection.

20. The centrifugal pump as claimed in claim 11, wherein
the unreleasable connection is a welded connection.

21. The centrifugal pump as claimed in claim 11, wherein
at least one of generatively manufactured segments has a strength-increasing internal lattice structure.

22. A method of operating a centrifugal pump, the centrifugal pump including at least one impeller and a guide device arranged downstream of the at least one impeller, the guide device being formed from at least two generatively manufactured segments, comprising the steps of:
introducing a flowing medium into a first one of the at least one impellers;
transferring the flowing medium from the first one of the at least one impellers to the guide device; and
converting in the at least two generatively manufactured segments at least a portion of a velocity of the flowing medium to an increased pressure of the flowing medium as the flowing medium passes from an inlet of the guide device to an outlet of the guide device.
